(19) United States
(12) Patent Application Publication
(10) Pub. No.: US 2009/0195113 A1
(43) Pub. Date: Aug. 6, 2009

(54) INDUCTION MACHINE STATOR APPARATUS AND METHOD

(75) Inventors: Sergei Kolomeitsev, Orem, UT (US); Omun Kwon, Orem, UT (US)

Correspondence Address: HOLLAND & HART LLP, 60 E. South Temple, Suite 2000, P.O. Box 11583, Salt Lake City, UT, 84110, US

(73) Assignee: Raser Technologies, Provo, UT (US)

(21) Appl. No.: 12/014,426

(22) Filed: Jan. 15, 2008

(51) Int. Cl. H02K 1/16; H02K 15/02; H02K 15/16; H02K 17/00; H02K 17/02; H02K 17/42; H02K 1/12

(52) U.S. Cl. 310/216.091; 310/168; 310/166; 29/596

(57) ABSTRACT

A stator for an alternating-current induction machine, the stator comprising a cylindrical stator core. The stator may also comprise a first stator tooth. The first stator tooth may comprise a proximal end extending from the cylindrical stator core and a distal end comprising an outer surface positioned to face a rotor. A first arc of the outer surface may be eccentric relative to the cylindrical stator core. Various additional stator designs and methods are also disclosed.

### BACKGROUND

Induction machines are often rugged, reliable, and cost-effective, and they have become the workhorses of industry. Devices as diverse as large industrial machines, air conditioning systems, and refrigerators use induction motors. Indeed, a substantial percentage of all electrical power produced in the United States may be consumed by induction motors. Thus, inefficiencies in induction motors may result in substantial energy losses.

Induction machines may include two basic components-a stationary component (a stator) and a rotating component (a rotor). The stator and rotor may typically be made with silicon steel, copper, and aluminum. An air gap may separate the stator and the rotor. In an induction motor, the stator may include a number of teeth with slots separating each tooth. The rotor may also include a number of teeth. An alternating current applied to windings around the stator teeth may produce a rotating magnetic field that induces a current in windings around the rotor teeth. The current in the rotor windings may create a magnetic field that interacts with the rotating magnetic field created by the stator, which may cause the rotor to turn.

There are several components of losses in induction machines. Induction machine losses include stator and rotor ohmic losses, core loss, friction and windage loss, and stray load losses. Some induction machine losses may be related to the magnetic fields in the motors. These magnetic fields may be described as a set of harmonics. The fundamental harmonics of magnetic flux and current may produce output power of an induction motor, while high harmonics may cause stray load losses. Stray load losses are the losses associated with high harmonics (e.g., harmonics higher than the fundamental harmonics of current and magnetic flux). A significant element of stray load losses may be associated with harmonics related to slots between stator teeth (slot harmonics).

Stator tooth profiles may affect slot harmonics. Conventional induction machines have stator tooth profiles that are parallel to the air gap surface (i.e., the stator tooth top is arched and concentric with the rotor surface). This conventional construction may cause substantial slot harmonics, which may result in increased stray load losses (e.g., core loss, rotor bar loss, etc). Thus, minimizing slot harmonics may result in better overall efficiency of induction machines.

### SUMMARY

According to certain embodiments, a stator for an alternating-current induction machine may comprise a cylindrical stator core. The stator may also comprise a first stator tooth. The first stator tooth may include a proximal end extending from the cylindrical stator core. The first stator tooth may also comprise a distal end with an outer surface positioned to face a rotor. A first arc of the outer surface may be eccentric relative to the cylindrical stator core. The outer surface may comprise at least one arcuate section. The arcuate section may form an arcuate recess in the first stator tooth.

According to at least one embodiment, the outer surface may comprise a plurality of linear sections, and the first arc of the outer surface may comprise an arcuate path connecting end points of at least two linear sections in the plurality of linear sections. In at least one embodiment, the plurality of linear sections may comprise four sections. First and second sections in the plurality of linear sections may form a first triangular recess in the outer surface, and second and third sections in the plurality of linear sections may form a second triangular recess in the outer surface.

In various embodiments, the stator may comprise a plurality of stator teeth, and the plurality of stator teeth may comprise the first stator tooth. Each tooth in the plurality of stator teeth may comprise a surface of a distal end that is dimensioned to be eccentric relative to the cylindrical stator core. According to at least one embodiment, the alternating-current induction machine may comprise an alternating-current induction motor. Alternatively, the alternating-current induction machine may comprise an alternating-current induction generator.

According to certain embodiments, an apparatus may comprise an alternating-current induction machine. The alternating-current induction machine may comprise a rotor with an axis of rotation. The alternating-current induction machine may also comprise a stator-tooth surface that faces the rotor. The stator-tooth surface may be dimensioned such that a first location on the stator-tooth surface is a first distance from the axis of rotation. A second location on the stator-tooth surface may be a second distance from the axis of rotation. A third location on the stator-tooth surface may be a third distance from the axis of rotation. The first distance may be longer than the second and third distances, and the first location may be between the second and third locations.

In at least one embodiment, the stator-tooth surface may comprise an arc, and the first, second, and third locations may be points on the arc. According to various embodiments, the stator-tooth surface may comprise at least one of a first linear section comprising the first location, a second linear section comprising the second location, and/or a third linear section comprising the third location. In some embodiments, the second and third locations are the same distance from the axis of rotation. In various embodiments, the alternating-current induction machine may be at least one of an alternating-current induction motor or an alternating-current induction generator.

According to certain embodiments, an apparatus may comprise an alternating-current induction machine. The alternating-current induction machine may comprise a rotor comprising an outer surface, a stator comprising a first stator tooth with a stator-tooth surface that faces the outer surface of the rotor, and an irregular air gap between the outer surface of the rotor and the stator-tooth surface. The stator-tooth surface may be dimensioned such that the irregular air gap comprises at least two different lengths.

In some embodiment, the stator may comprises a plurality of stator teeth. The plurality of stator teeth may comprise the first stator tooth. The stator may also comprise a plurality of stator slots between each tooth in the plurality stator teeth and a first plurality of conductive windings wound around the plurality of stator teeth through the plurality of stator slots. In various embodiments, the rotor may comprise a plurality of rotor teeth, a plurality of rotor slots between each tooth in the plurality rotor teeth, and a second plurality of conductive windings wound around the plurality of rotor teeth through the plurality of rotor slots.

In some embodiments, the irregular air gap may at least partially induce a stator-slot harmonic to have a first value. In contrast, a regular air gap between concentric stator tooth and rotor surfaces may at least partially induce the stator-slot harmonic to have a second value, and the first value may be less than the second value. In at least one embodiment, the alternating-current induction machine may comprise at least one of an alternating-current induction motor and an alternating-current induction generator.

According to certain embodiments, a method for manufacturing an alternating-current induction machine may comprise providing a rotor. The rotor may comprise an axis of rotation. The method may also comprise forming a stator comprising a stator tooth with a stator-tooth surface dimensioned to face the rotor. The stator-tooth surface may be dimensioned such that a first location on the stator-tooth surface is farther from the axis of rotation than second and third locations on the stator-tooth surface. The first location may be between the second and third locations. The method may also comprise positioning the rotor within the stator.

According to some embodiments, the stator-tooth surface comprises an arc, and the first, second, and third locations may be points on the arc. The stator-tooth surface may also comprise at least one of a first linear section comprising the first location, a second linear section comprising the second location, and/or a third linear section comprising the third location.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an exemplary induction motor according to certain embodiments.

FIG. 2 is a side view of a stator of an induction machine according to certain embodiments.

FIG. 3 is a perspective view of a rotor and stator of an induction machine according to certain embodiments.

FIG. 4 is a side view of an exemplary rotor and stator of an induction machine according to certain embodiments.

FIG. 5 is a side view of an exemplary air gap between a stator and a rotor according to certain embodiments.

FIG. 6 is a side view of an exemplary stator-tooth profile according to certain embodiments.

FIG. 7 is a side view of another exemplary stator-tooth profile according to certain embodiments.

FIG. 8 is a side view of another exemplary stator-tooth profile according to certain embodiments.

FIG. 9 is a side view of another exemplary stator-tooth profile according to certain embodiments.

FIG. 10 is a side view of another exemplary stator-tooth profile according to certain embodiments.

FIG. 11 is a flow diagram of an exemplary method of manufacturing an alternating-current induction machine according to certain embodiments.

FIG. 12 is a chart comparing slot harmonics of a traditional induction motor with slot harmonics of a motor according to embodiments disclosed herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The following is intended to provide a detailed description of various exemplary embodiments and should not be taken to be limiting in any way. Various exemplary methods and systems for improving induction machine efficiency are disclosed herein. For example, the present disclosure presents stator tooth profiles that may reduce slot harmonics in induction machines. Embodiments of the instant disclosure apply to various types of induction machines, such as induction motors and induction generators. As discussed in greater detail below, embodiments of the instant disclosure may provide various advantages and features over prior induction machines.

According to some embodiments, stator-tooth shaping may provide improved efficiency for induction machines by mitigating stator slot harmonic losses. Stator-tooth profiles may be shaped to reduce harmonic flux for space harmonic Magneto-Motive Forces (MMF). Stray load losses generated by high harmonic components may be reduced by modulating stator-tooth profiles to minimize harmonic flux resulting from MMF. The modulation process may involve the introduction of increased curvature or other shapes in stator tooth profiles. Shaping stator tooth profiles results in stator tooth profiles that may be eccentric (i.e., non-concentric relative to an axis of rotation or deviating from a circular form) with respect to a center point of the stator.

Stator tooth shaping may provide an additional design optimization variable for slot harmonic reduction. As previously noted, the shaped stator teeth disclosed herein may reduce the level of the slot space harmonics, thereby reducing harmonics in induced rotor bar Electro-Motive Force (EMF). The shaped stator teeth disclosed herein may also improve overall motor efficiency by reducing high harmonic core losses, rotor I²R losses, stray load loss, and motor acoustic noise.

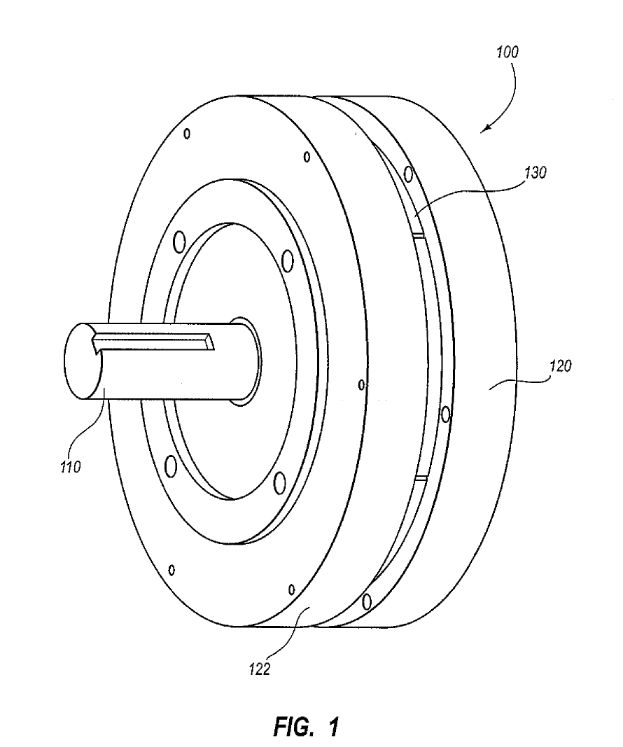

Stator-tooth shaping technology disclosed herein may be applied to induction motors, induction generators, or any other suitable types of induction machines. FIG. 1 shows an exemplary induction motor 100. Motor 100 may include two circular end bells 120 and 122 supporting a circular stator core 130. In some embodiments, stator core 130 may be formed from a metallic material such as iron and may contain multiple teeth surrounded by wire windings. A shaft 110 may extend from motor 100 and may be attached to a rotor within motor 100. Motor 100 may include a squirrel-cage rotor. In other embodiments, induction motors may comprise wound rotors or any other suitable types of rotors.

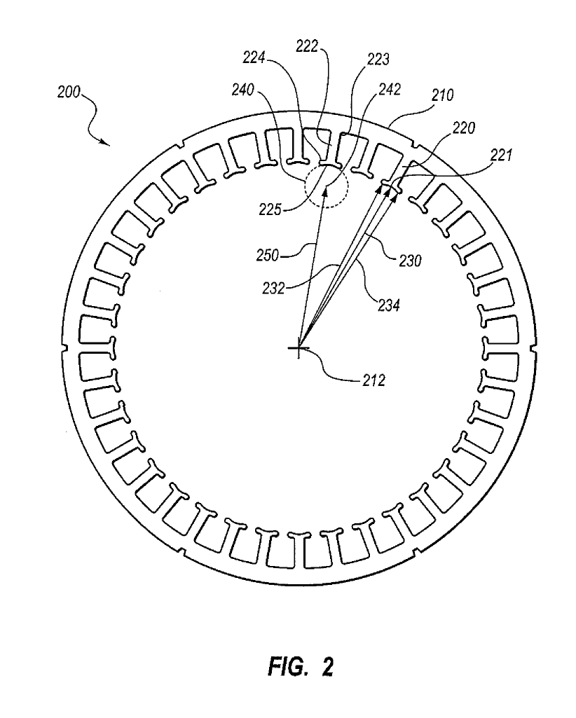

FIG. 2 shows an exemplary stator 200. Stator 200 may comprise a stator core 210. Stator teeth 220 and 222 may extend from stator core 210. Stator core 210 may be circular in shape and may have a center point 212. A plurality of stator teeth may extend from stator core 210 toward center point 212, and the plurality of stator teeth may include stator teeth 220 and 222. Stator 200 includes thirty-six stator teeth. In some embodiments, stator 200 may have any suitable number of stator teeth, including more or less than thirty-six stator teeth. Also, stator teeth may have any suitable height, width, and depth dimensions.

Stator tooth 222 may include a proximal end 223 extending from stator core 210. Stator 222 may also include a distal end 224. Distal end 224 may comprise an outer surface 225. Outer surface 225 may be positioned to face a rotor (not shown). In other words, outer surface 225 may face center point 212. Outer surface 225 of distal end 224 may also be referred to as a stator-tooth profile or a stator-tooth surface.

Outer surface 225 of distal end 224 may not be shaped like traditional stator teeth. Traditional stator teeth may comprise a profile with an arch that is concentric relative to the stator core. In contrast, outer surface 225 may comprise an arch that is eccentric relative to stator core 210. As used herein, the phrase “eccentric relative to” generally refers to a shape that does not have the same center point as (i.e., non-concentric) as a complimentary shape, or deviating from a circular form.

Stator core 210 is centered around center point 212. In contrast, the arc of outer surface 225 of stator tooth 222 is centered about center point 242. In other words, outer surface 225 is concentric with a circle 240 that is centered around center point 242. Circle 240 and outer surface 225 are not concentric with stator core 210 because center point 242 is in a different location than center point 212. Center point 242 may be a distance 250 from center point 212. In various embodiments, center point 242 may be any suitable distance from center point 212, including distances longer or shorter than distance 250.

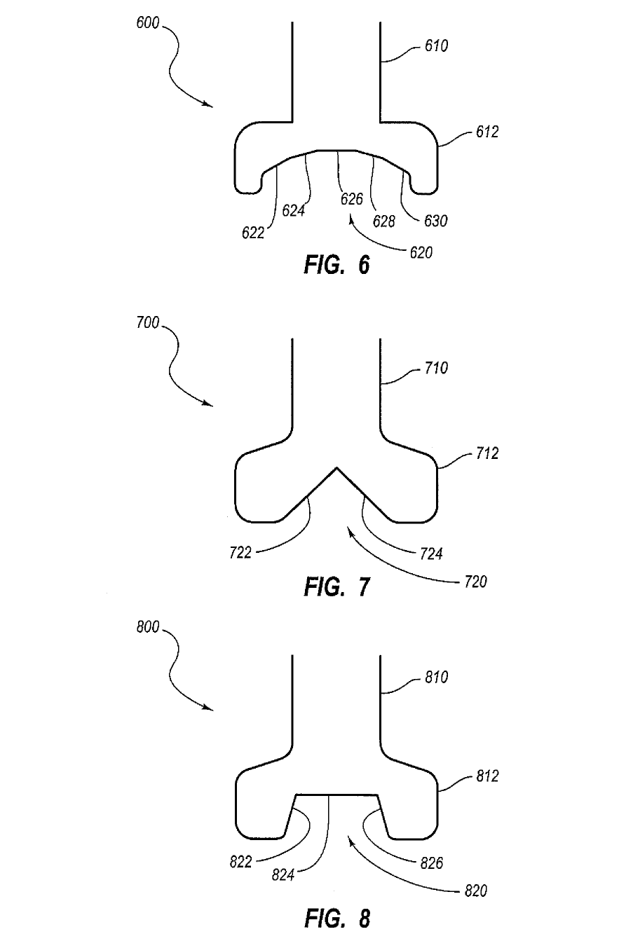

The profile of stator-tooth 222 (i.e., outer surface 225) may be an arcuate shape. This arcuate shape may form an arcuate recess in stator-tooth 222. In some embodiments, each stator-tooth in stator 200 may have a stator tooth profile that is arched like outer surface 225 of stator-tooth 222. FIG. 2 illustrates such an embodiment. In other embodiments, one or more of the stator teeth in a stator may have different profiles. For example, some stator teeth may have traditional profiles that are arched to be concentric with the stator core while other teeth may have profiles shaped like stator-tooth 222. FIGS. 6-10 show various other examples of stator-tooth profiles according to embodiments of the instant disclosure.

Stator tooth 220 may comprise an outer surface 221. A first location on outer surface 221 may be a distance 232 from center point 212. A second location on outer surface 221 may be a distance 230 from center point 212. A third location on outer surface 221 may be a distance 234 from center point 212. Distance 230 may be longer than distances 232 and 234. Thus, outer surface 221 may be eccentric relative to stator core 210. In some embodiments, outer surface 221 may be sloped such that distance 234 is longer than distance 230 and distance 230 is longer than distance 232. In other embodiments, distance 230 may be longer than both distances 232 and 234, while distance 232 may be longer than distance 234. Various other stator-tooth configurations also fall within the scope of the instant disclosure.

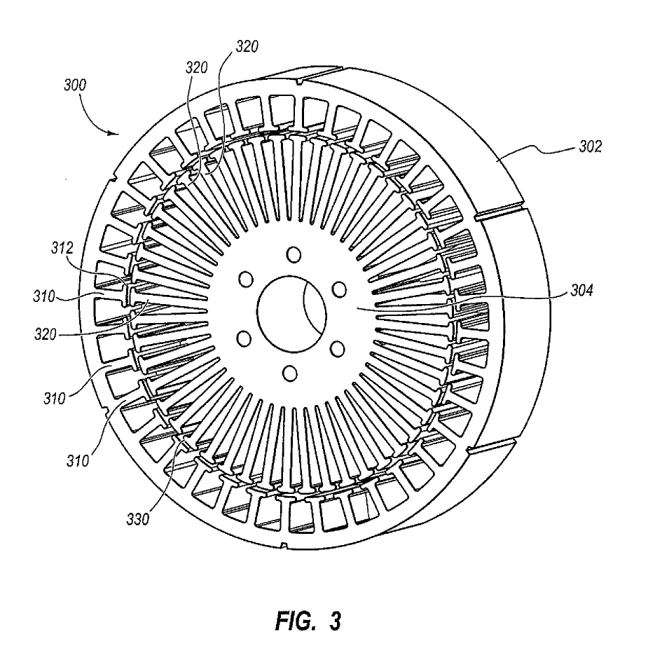

FIG. 3 shows a stator and rotor assembly 300. Assembly 300 includes a stator 302 and a rotor 304. FIG. 3 shows that stator 302 may be cylindrical or tubular in shape. Stator 302 may include a plurality of stator teeth 310, and rotor 304 may include a plurality of rotor teeth 320. Outer surfaces 312 of distal ends of stator-teeth 310 may face rotor teeth 320. An air gap 330 may separate stator 302 and rotor 304. An alternating current may be applied to windings (not shown) around stator teeth 310. This alternating current may produce a rotating magnetic field that induces a current in windings (not shown) around rotor teeth 320. The current in the rotor windings may create a magnetic field that causes the rotor to turn, as previously explained.

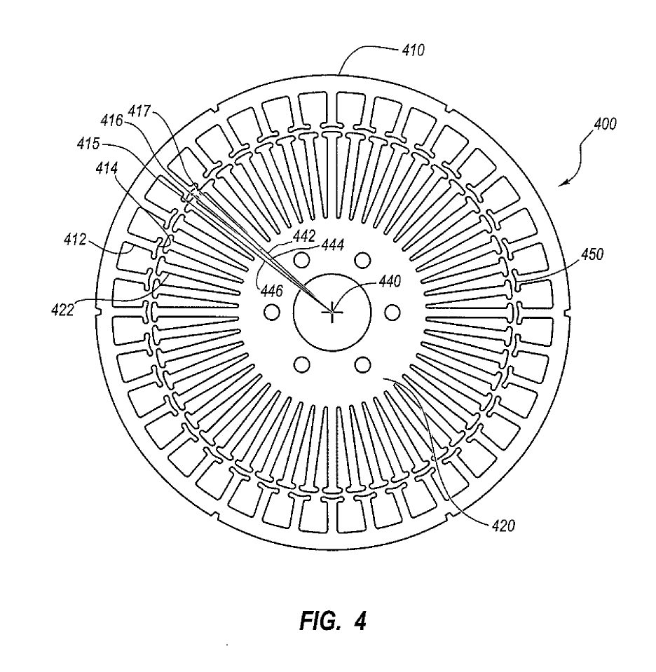

FIG. 4 shows a stator-rotor assembly 400. Assembly 400 may include a stator 410 and a rotor 420. Stator 410 may include a stator tooth 412 among a plurality of stator teeth, and rotor 420 may include a rotor tooth 422 among a plurality of rotor teeth. Rotor 420 may also include an axis of rotation 440. Axis of rotation 440 may be an axis about which rotor 420 rotates and may be located at a center point of rotor 420. Axis of rotation 440 may also be a center point of stator 410.

Stator-tooth 412 may comprise a stator-tooth surface 414 that faces rotor 420 and rotor tooth 422. Stator-tooth surface 414 may be dimensioned such that a first location 415 on stator-tooth surface 414 is a first distance 446 from axis of rotation 440. A second location 416 on stator-tooth surface 414 may be a second distance 444 from axis of rotation 440. A third location 417 on stator-tooth surface 414 may be a third distance 442 from axis of rotation 440. In some embodiments, distance 444 may be longer than distances 442 and 446. Also, location 416 may be between locations 415 and 417. Such a configuration of stator-tooth surface 414 may provide a stator-tooth surface that is eccentric relative to axis of rotation 440.

Assembly 400 also shows an air gap 450 between an outer surface of rotor 420 and an inner surface of stator 410. The outer surface of rotor 420 may be defined by the outer surfaces or profiles of the rotor teeth in rotor 420. Similarly, the inner surface of stator 410 may be defined by the inner surfaces or profiles of the stator teeth in stator 410. The stator-tooth surfaces of stator 410 may be dimensioned such that air gap 450 is irregular or non-uniform.

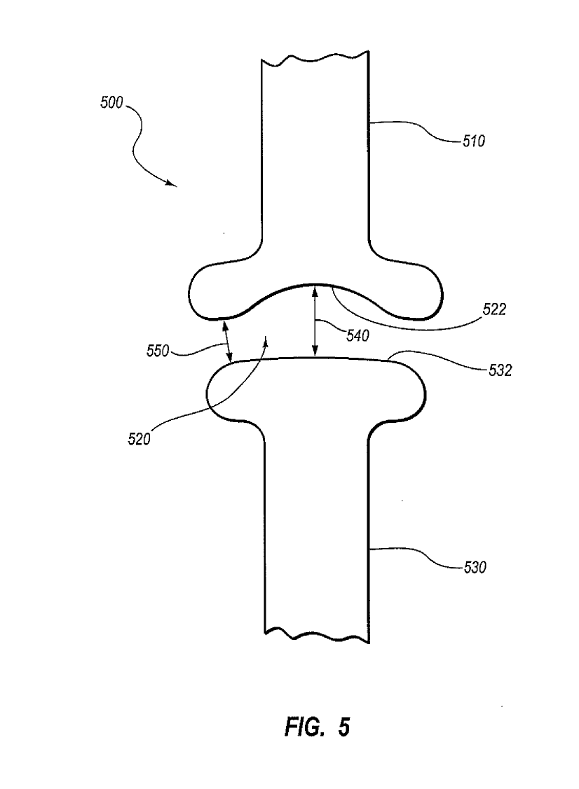

FIG. 5 shows an irregular air gap 520 between a stator-tooth surface 522 of a stator tooth 510 and a rotor-tooth surface 532 of a rotor tooth 530. Generally, an irregular air gap may be an air gap with two or more different lengths. A length of air gap 520 may be a distance between the outer surface of the rotor (e.g., rotor-tooth surface 532) and stator-tooth surface 522.

In traditional stator-rotor assemblies, the air gap may be uniform between the stator and rotor surfaces. In contrast, assembly 500 shows that air gap 520 is irregular. In other words, air gap 520 comprises at least two different lengths. FIG. 5 shows that air gap 520 comprises a first length 550 that is shorter than a second length 540. Irregular air gap 520 may at least partially induce a smaller stator-slot harmonic (e.g., space harmonic due to stator tooth openings) than a traditional stator-rotor assembly. In other words, irregular air gap 520 may at least partially induce a stator-slot harmonic to have a first value. In contrast, a regular air gap between concentric stator-tooth and rotor surfaces (i.e., a uniform air gap) may at least partially induce the stator-slot harmonic to have a second value, and the first value may be less than the second value. Thus, one or more stator-slot harmonics may be reduced by shaping the stator-tooth surface to create an irregular air gap between stator and rotor surfaces.

FIGS. 6-10 show various other examples of stator-tooth shapes. FIG. 6 shows a stator tooth 600 with an arm 610 and a head 612. Head 612 may include a stator-tooth surface 620. Stator-tooth surface 620 may comprise a plurality of linear sections 622, 624, 626, 628 and 630. Linear sections 622, 624, 626, 628 and 630 may all have equal lengths and may be connected at equal angles. In other embodiments, linear sections 622, 624, 626, 628 and 630 may have various different lengths and may form various different angles. While FIG. 6 shows five linear sections, any suitable number of linear sections may form stator-tooth surface 620.

FIG. 7 shows a stator-tooth 700 with a stator arm 710 and a stator head 712. Stator head 712 may include a stator-tooth surface 720. Stator-tooth surface 720 may comprise a first linear section 722 and a second linear section 724 to form a triangular surface or recess in stator head 712. In some embodiments, sections 722 and 724 may be curved rather than being linear.

FIG. 8 shows a stator tooth 800 with a stator-tooth arm 810 and a stator-tooth head 812. Stator-tooth head 812 may comprise a stator-tooth surface 820. Stator-tooth surface 820 may comprise three linear sections 822, 824, and 826 to form a trapezoidal-shaped stator-tooth surface. In some embodiments, linear section 822 may be longer than linear section 826. In other embodiments, linear section 826 may be longer than linear section 822. In at least one embodiment, linear sections 822 and 826 may have equal lengths.

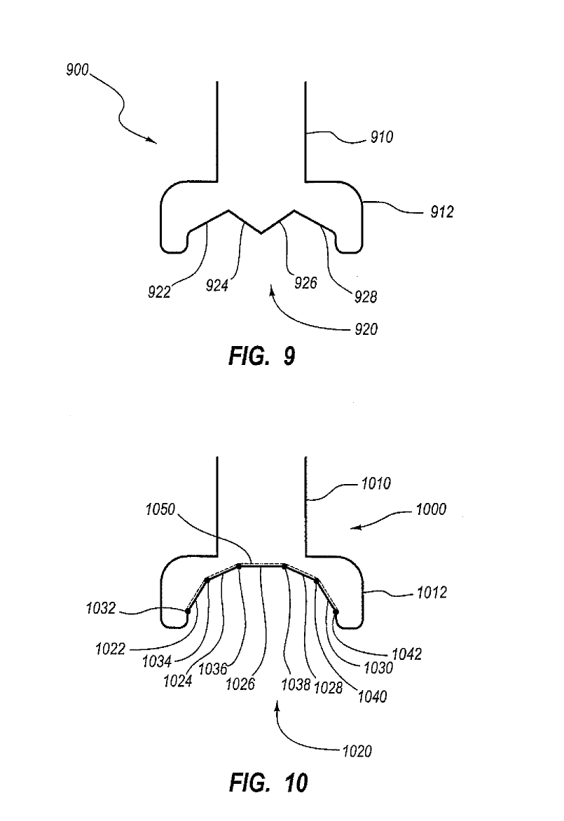

FIG. 9 shows a stator 900 with a stator-tooth arm 910 and a stator-tooth head 912. Stator-tooth head 912 may comprise a stator-tooth surface 920. Stator-tooth surface 920 may comprise four linear sections 922, 924, 926, and 928. Linear sections 922 and 924 may form a first triangular recess in stator-tooth surface 920, and linear sections 926 and 928 may form a second triangular recess in stator-tooth surface 920. In some embodiments, stator-tooth surface 920 may be shaped to include three or more triangular-shaped recesses. In other embodiments, one or more of linear sections 922, 924, 926, and 928 may be curved or may be any other suitable shape.

FIG. 10 illustrates a stator-tooth 1000 with a stator-tooth arm 1010 and a stator-tooth head 1012. Stator-tooth head 1012 may comprise a stator-tooth surface 1020. Stator-tooth surface 1020 may comprise sections 1022, 1024, 1026, 1028 and 1030. Sections 1022, 1024, 1026, 1028, and 1030 may intersect at points 1034, 1036, and 1038, and 1040 respectively. Points 1032, 1034, 1036, 1038, 1040, and 1042 may form an arcuate path 1050 that connects the end points of sections 1022, 1024, 1026, 1028 and 1030.

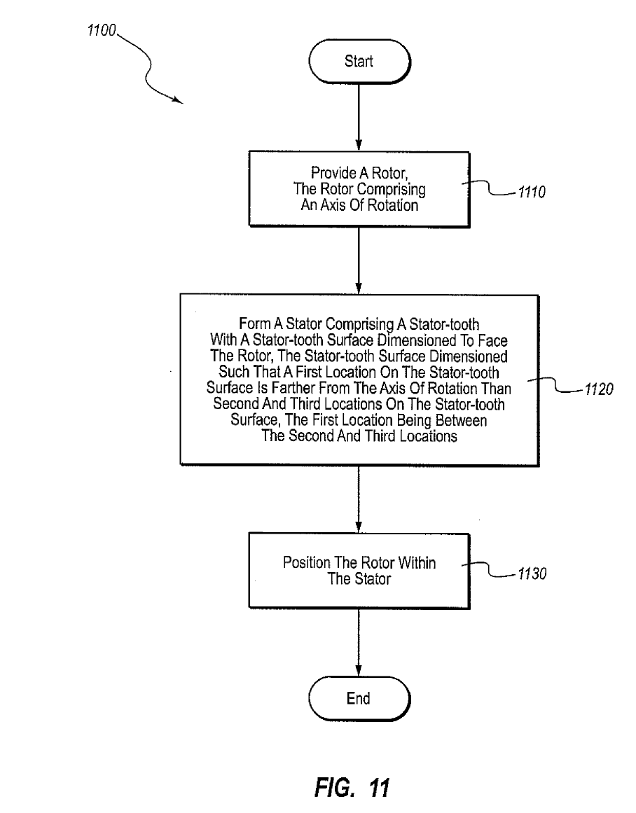

FIG. 11 shows a method for manufacturing an alternating-current induction machine. A manufacturer may provide a rotor (step 1110). The rotor may be any suitable size, shape, and/or configuration. The rotor may comprise an axis of rotation. The manufacturer may also form a stator that comprises a stator-tooth with a stator-tooth surface dimensioned to face the rotor (step 1120). The stator-tooth surface may be dimensioned such that a first location on the stator-tooth surface is farther from the axis of rotation than second and third locations on the stator-tooth surface. The first location may be between the second and third locations. The manufacturer may then position the rotor within the stator (step 1130) to form a induction machine according to certain embodiments of the instant disclosure.

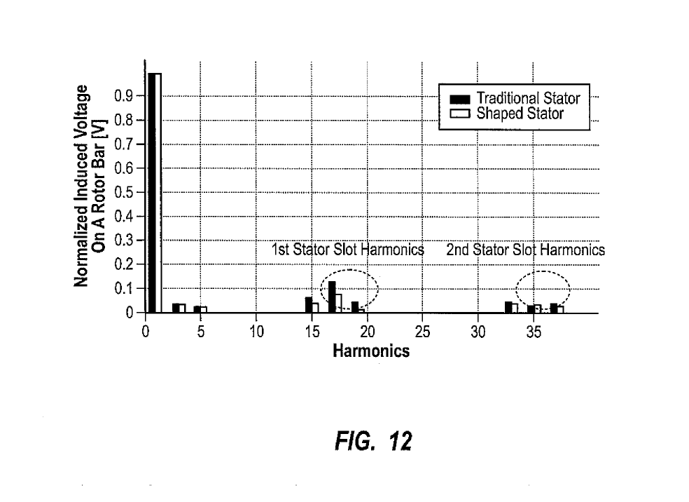

The stator designs disclosed herein may provide induction machines with lower stray load losses, core losses, eddy current losses, and various other types of losses. The stator designs disclosed herein may also provide various other features and advantages. In some embodiments, optimal stator tooth surface curvature and may depend on the slot and pole number and geometry of an induction machine. The optimum curvature for an induction machine may be determined by using numerical simulations (e.g., finite element simulation of different curvature patterns) at different load points. The simulations may provide a space-harmonic analysis, such as the space-harmonic analysis illustrates in FIG. 12.

FIG. 12 is a graph showing a comparison of rotor bar EMF of a traditional induction motor and an induction motor with a sloped or shaped profile according to embodiments disclosed herein. FIG. 12 shows the results of a space-harmonic analysis that involved the computation of induced rotor bar voltage when a suitable frequency and voltage was applied to the stator winding. As shown, an induction motor with sloped stator teeth may significantly reduce stator slot harmonics. Laboratory tests also confirm that sloped stator teeth also reduce the acoustic noise performance of induction machines.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

We claim:

1. A stator for an alternating-current induction machine, the stator comprising:
a cylindrical stator core;
a first stator tooth, the first stator tooth comprising:
a proximal end extending from the cylindrical stator core;
a distal end comprising an outer surface positioned to face a rotor, a first arc of the outer surface being eccentric relative to the cylindrical stator core.

2. The stator of claim 1, wherein the outer surface comprises at least one arcuate section.

3. The stator of claim 2, wherein the arcuate section forms an arcuate recess in the first stator tooth.

4. The stator of claim 1, wherein:
the outer surface comprises a plurality of linear sections;
the first arc of the outer surface comprises an arcuate path connecting end points of at least two linear sections in the plurality of linear sections.

5. The stator of claim 4, wherein:
the plurality of linear sections comprises four sections;
first and second sections in the plurality of linear sections form a first triangular recess in the outer surface;
second and third sections in the plurality of linear sections form a second triangular recess in the outer surface.

6. The stator of claim 1, further comprising:
a plurality of stator teeth, the plurality of stator teeth comprising the first stator tooth, wherein each tooth in the plurality of stator teeth comprises a surface of a distal end that is dimensioned to be eccentric relative to the cylindrical stator core.

7. The stator of claim 1, wherein the alternating-current induction machine comprises an alternating-current induction motor.

8. The stator of claim 1, wherein the alternating-current induction machine comprises an alternating-current induction generator.

9. An apparatus comprising:
an alternating-current induction machine comprising:
a rotor, the rotor comprising an axis of rotation;
a stator-tooth surface that faces the rotor, the stator-tooth surface dimensioned such that:
a first location on the stator-tooth surface is a first distance from the axis of rotation;
a second location on the stator-tooth surface is a second distance from the axis of rotation;
a third location on the stator-tooth surface is a third distance from the axis of rotation;
the first distance is longer than the second and third distances;
the first location is between the second and third locations.

10. The apparatus of claim 9, wherein the stator-tooth surface comprises an arc, the first, second, and third locations being points on the arc.

11. The apparatus of claim 9, wherein the stator-tooth surface comprises at least one of:
a first linear section comprising the first location;
a second linear section comprising the second location;
a third linear section comprising the third location.

12. The apparatus of claim 9, wherein the second and third locations are the same distance from the axis of rotation.

13. The apparatus of claim 9, wherein the alternating-current induction machine is at least one of:
an alternating-current induction motor.
an alternating-current induction generator.

14. An apparatus comprising:
an alternating-current induction machine comprising:
a rotor comprising an outer surface;
a stator comprising a first stator tooth with a stator-tooth surface that faces the outer surface of the rotor;
an irregular air gap between the outer surface of the rotor and the stator-tooth surface, the stator-tooth surface being dimensioned such that the irregular air gap comprises at least two different lengths.

15. The apparatus of claim 14, wherein:
the stator comprises:
a plurality of stator teeth, the plurality of stator teeth comprising the first stator tooth;
a plurality of stator slots between each tooth in the plurality stator teeth;
a first plurality of conductive windings wound around the plurality of stator teeth through the plurality of stator slots;
the rotor comprises:
a plurality of rotor teeth;
a plurality of rotor slots between each tooth in the plurality rotor teeth;
a second plurality of conductive windings wound around the plurality of rotor teeth through the plurality of rotor slots.

16. The apparatus of claim 14, wherein:
the irregular air gap at least partially induces a stator-slot harmonic to have a first value;
a regular air gap between concentric stator tooth and rotor surfaces at least partially induces the stator-slot harmonic to have a second value;
the first value is less than the second value.

17. The apparatus of claim 14, wherein the alternating-current induction machine is at least one of:
an alternating-current induction motor.
an alternating-current induction generator.

18. A method for manufacturing an alternating-current induction machine, the method comprising:
providing a rotor, the rotor comprising an axis of rotation;
forming a stator comprising a stator tooth with a stator-tooth surface dimensioned to face the rotor, the stator-tooth surface dimensioned such that a first location on the stator-tooth surface is farther from the axis of rotation than second and third locations on the stator-tooth surface, the first location being between the second and third locations;
positioning the rotor within the stator.

19. The method of claim 18, wherein the stator-tooth surface comprises an arc, the first, second, and third locations being points on the arc.

20. The method of claim 18, wherein the stator-tooth surface comprises at least one of:
a first linear section comprising the first location;
a second linear section comprising the second location;
a third linear section comprising the third location.
